(19) United States
(12) Patent Application Publication
(10) Pub. No.: US 2003/0104135 A1
(43) Pub. Date: Jun. 5, 2003

(54) Method and composition for treating wood

(76) Inventors: Robert N. Grantham, Fort Myers, FL (US); James R. Weaver III, Pensacola, FL (US)

Correspondence Address: WEBB ZIESENHEIM LOGSDON ORKIN & HANSON, P.C., 700 Koppers Building, 436 Seventh Avenue, Pittsburgh, PA, 15219-1818, US

(21) Appl. No.: 10/281,919

(22) Filed: Oct. 28, 2002

Related U.S. Application Data
(60) Provisional application No. 60/348,465, filed on Oct. 29, 2001.

(51) Int. Cl. B05D 3/02; A01N 59/00; A01N 59/14

(52) U.S. Cl. 427/397.8; 106/15.05; 106/18.3

(57) ABSTRACT

A method and a composition for treating wood products and a treated wood product prepared according to such methods where wood is treated by providing a wood to be treated, providing a treatment solution which includes an alkali silicate and a sealant composition, pressure treating the wood with the treatment solution, and applying energy to the treated wood.

### CROSS-REFERENCE TO RELATED APPLICATION

This application claims the benefit of U.S. Provisional Patent Application Serial No. 60/348,465, filed Oct. 29, 2001, and entitled “Method and Composition for Treating Wood,” which is herein incorporated by reference.

### BACKGROUND OF THE INVENTION

1. Field of the Invention

The present invention is directed to a formaldehyde-free method for treating wood products, especially lumber, to strengthen the wood products and to render the wood products flame retardant and resistant to moisture and insects.

2. Description of Related Art

Over the years, much effort has been directed to solving the problem of imparting fire-inhibiting properties to wood, as well as resistance to the growth of fungi, attack by termites, and moisture. Initial efforts, aimed at imparting fire-inhibiting properties to wood, included impregnation of the wood with fire-inhibiting salts that are applied in an aqueous solution. For example, ammonium sulfate, sodium sulfate or magnesium sulfate, monoammonium phosphate or diammonium phosphate, borates, or the like have been used. The fire-inhibiting or flameproofing effect of such salts may be based on the fact that their decomposition is endothermic and that on being heated, they easily form salts which envelop the inflammable substance, so that combustible gases are not given off, and the wood carbonizes without any flames being formed. The use of such salts has a shortcoming, however, as even though they could easily impregnate the wood, they were rather easily washed out of the wood again due to their excellent water solubility.

U.S. Pat. No. 3,935,341 to Sorensen et al. discloses another method of imparting fire and pest resistance to wood. This method renders wood fire resistant by impregnating the wood with a solution of phenol and a fire-inhibiting salt, drying the wood, followed by treating the wood with a solution of formaldehyde which is polymerizable with the phenol. Heating the treated wood to dryness causes polymerization of the monomers. Wood products, such as those disclosed by Sorensen et al., have fallen out of favor in recent years due to the potential toxic environmental effects of residual formaldehyde in the treated wood.

U.S. Pat. Nos. 3,945,835 and 4,038,086 to Clarke et al. and U.S. Pat. No. 4,103,000 to Hartford disclose various aqueous wood treating and/or preservative compositions that contain copper ammonium and/or zinc ammonium cations and arsenic or arsenious anions, to make, for example, chromated copper arsenate wood treating compositions. While effective at preserving wood, these materials are able to be leached from the wood by water and, owing to the toxic nature of the compositions, can create a potential to harm the environment.

U.S. Pat. No. 3,974,318 to Lilla discloses a process whereby water soluble silicate compositions are applied to a wood product, and the product is subsequently treated with a water soluble metallic salt compound to form a water insoluble metallic silicate in the wood product. Improvements on this method have been disclosed in U.S. Pat. No. 5,478,598 to Shiozawa, and U.S. Pat. Nos. 6,146,766 and 6,040,057 to Slimak et al. However, in these cases, the silicate based treatment compositions can be leached from the wood by exposure to environmental water and moisture, which eventually causes the treated wood to loose its fire, insect, termite, and microbial attack resistance. U.S. Pat. No. 6,235,349 to Grantham et al. discloses further improvements utilizing a wood treating composition that includes a silicate, a wetting agent and a rheology modifier. However, this approach also has its limitations.

There is an ongoing need for an environmentally safe composition and method for treating wood to render fire-inhibiting properties, as well as resistance to the growth of fungi, attack by termites, and moisture, especially lumber, wherein the treatment composition is resistant to being removed or leached from the treated wood due to exposure to environmental water and moisture.

### SUMMARY OF THE INVENTION

The present invention is directed to a method and a composition for treating wood products and a treated wood product prepared according to the methods of the present invention. The method provides for treating the wood products with a treatment solution and includes the steps of:

(a) providing wood or a wood product to be treated;

(b) providing a treatment solution which includes:

(i) an alkali silicate; and

(ii) a sealant composition;

(c) pressure treating the wood with the treatment solution; and

(d) applying energy to the treated wood.

The present invention is also directed to wood treated using the above-described method.

These and other advantages of the present invention will be clarified in the description of the preferred embodiments taken together with the examples.

### DESCRIPTION OF THE PREFERRED EMBODIMENT(S)

Unless otherwise indicated, all numbers or expressions referring to quantities of ingredients, reaction conditions, etc., used herein are to be understood as modified in all instances by the term “about.”

Various numerical ranges are disclosed in this patent application. Because these ranges are continuous, they include every value between the minimum and maximum values. Unless expressly indicated otherwise, the various numerical ranges specified in this application are approximations.

As used herein and in the claims, the term “solution” refers to any homogeneous mixture of at least one material in a solvent. The term “solution” is not meant to exclude heterogeneous mixtures, where the material may not be completely miscible in the solvent, but is uniformly dispersed therein, or may become uniformly dispersed therein with the application of moderate mixing.

As used herein and in the claims, the term “water insoluble” refers to materials that do not readily form homogeneous solutions in water. Generally, if distinct particulates are visible at a concentration of 0.1 g/100 g of distilled water at a pH of from 6.0-8.0, the material will be considered water insoluble.

The present invention is generally directed to a method for treatment of wood and wood products which preserves the substrate or substrate products and renders the substrate or substrate products fire, moisture, fungus, termite, and insect resistant.

As used herein and in the claims, the term “wood products” refers generally to products derived from wood, which includes, but is not limited to, oriented strand board (OSB), medium-density fiberboard (MDF), plywood, particleboard, paper products, natural wood products including both green and dried lumber, as well as products made or derived from wood chips, wood pulp, and/or wood fiber. The term “wood” includes green lumber. The treated wood products are generically useful for construction purposes, general construction methods, and as general construction materials. More specifically, for purpose of example only, the treated products may be used in flooring, fire doors, exterior beams and columns, fire panel materials and sheeting, and exterior sheeting, including siding, cabinet manufacturing, furniture manufacturing, railroad cross ties, landscape timbers, floor plating, fire-retardant lumber, door jambs, sea walls, countertops, exterior fascia material, and in window manufacturing. Other substrates upon which the present method may be applied include, but are not limited to, paper, cardboard, paper towels, sponges, porous plastics, and fabrics.

As used herein and in the claims, the term “green lumber” refers to wood that has a moisture content of at least 40%. The moisture content of the wood, usually expressed in a percentage, is a ratio of the amount of water in a piece of wood compared to the weight of such wood when all of the moisture has been removed. The moisture content may be determined by the moisture content on oven-dry basis method. In this method, the moisture content of wood is determined by weighing a given sample of wood (wet weight), placing it into an oven at a temperature not to exceed 100° C., until all of the moisture has been removed from the wood (the “oven-dry weight”). The oven-dry weight is then subtracted from the wet weight and the resultant is then divided by the oven-dry weight. The resultant figure is then multiplied by 100 to determine the moisture content percentage. When a tree, such as red or white oak, fir, maple, spruce, ash, southern yellow pine, or any one of the many species of trees that yield wood, that is useful in the production of wood products is initially cut down, it has a moisture content of anywhere from about 60% to 100%.

The treatment solution of the present invention is able to fully penetrate and preserve wood products, including green lumber. The treatment solution includes an alkali silicate, a sealant composition, and optionally, one or more wetting agents, one or more rheology modifiers, one or more bactericides or fungicides, and/or one or more fire retardant salts. The wood treatment components of the treatment solution include the alkali silicate, the bactericides, the fungicides, and the fire retardant salts.

Any suitable alkali silicate may be used in the present invention, so long as it is able to polymerize inside the treated wood after the application of energy. Suitable alkali silicates include, but are not limited to, sodium silicate, potassium silicate, and ammonium silicate. The alkali silicate is present in the treatment solution at a level of at least 4 percent by weight, often at least 6 percent by weight, typically at least 8 percent by weight, and in some cases at least 10 percent by weight. When the level of alkali silicate in the treatment solution is too low, the treated wood will not be adequately resistant to fire, decay, and infestation. The alkali silicate is present in the treatment solution at a level of up to 60 percent by weight, often up to 55 percent by weight, typically up to 50 percent by weight, and in some cases up to 45 percent by weight. When the level of alkali silicate is too high, the treatment solution may have a short shelf life as a result of a portion of the alkali silicate precipitating from solution. The alkali silicate may be present in the treatment solution in any range of values inclusive of those stated above.

Any suitable sealant composition may be used in the present invention, so long as it is able to retard or prevent the wood preserving components of the treatment solution from being leached or otherwise removed from the treated wood due to exposure to environmental water or moisture. Suitable sealant compositions include, but are not limited to, wax or paraffin-based materials, polymer-based materials, or mixtures thereof.

Suitable wax or paraffin-based sealant compositions include, but are not limited to, paraffin wax dispersed in mineral oil, such as is disclosed in U.S. Pat. No. 5,342,436 to Thrasher, and wax in the form of micronized particles as disclosed by U.S. Pat. No. 5,017,222 to Cifuentes et al., both of which are herein incorporated by reference.

Suitable polymer based sealant compositions include, but are not limited to, a mixture of a cyclodimethylsiloxane fluid and a polydiorganosiloxane-polyoxyalkylene copolymer, such as those disclosed in U.S. Pat. No. 4,218,250 to Kasprzak; oxyalkalene polymers, such as those disclosed in U.S. Pat. Nos. 5,506,001 and 5,460,751 to Ma et al.; pyridine containing polymers, such as those disclosed by U.S. Pat. No. 4,420,542 to Sowers; amine modified polybutadienes, such as those disclosed in U.S. Pat. No. 4,269,626 to Gorke et al.; vinyl polymer latexes, such as those disclosed in U.S. Pat. Nos. 4,011,090 and 3,945,834 to Clarke et al.; and styrene butadiene copolymers, such as hydrogenated styrene butadiene copolymers, non-limiting examples of which are disclosed in U.S. Pat. No. 5,777,043, thermosetting styrene butadiene copolymers, non-limiting examples of which are disclosed in U.S. Pat. No. 5,017,653 to Johnston, and a styrene-butadiene rubber (SBR) latex, which may be the product of a polymerization carried out in an emulsion system where a mixture of at least two monomers (styrene and butadiene) is mixed with an aqueous soap (or other surface active agent) solution containing the necessary polymerization initiators as is well known in the art. The final product is an oil-in-water emulsion of the resulting copolymer, i.e., a fluid latex. Examples of commercially available SBR latexes that may be used in the present invention include, but are not limited to the SYNTHOMER styrene butadiene latexes available from Synthomer Limited, Harlow, Essex, United Kingdom and the CP Modified S/B Latexes, the DL Modified S/B Latexes, the FC Modified S/B Latexes, the PB Modified S/B Latexes, the CT Modified S/B Latexes, the HS Hollow Sphere Plastic Pigment Latexes, the A Solid Plastic Pigment Latexes, the HS Solid Plastic Pigment Latexes and the PB Solid Plastic Pigment Latexes available from Dow Chemical Co., Midland, Mich.

Examples of sealant compositions that are mixtures of wax or paraffin-based sealants and polymer-based sealants include, but are not limited to, mixtures of the above-mentioned wax or paraffin-based sealant compositions and polymer-based sealant compositions, mixtures of a styrene block copolymer, styrene-butadiene copolymer, a moisture-curable silylated polyurethane prepolymer, an aromatic tackifier resin, a polar tackifier resin, a polyethylene wax, and an organo silane adhesion promoter as disclosed in U.S. Pat. No. 6,121,354 to Chronister, and a water-based polymeric binder and a wax hydrophobic filler as disclosed in U.S. Pat. No. 4,897,291 to Kim. A non-limiting example of suitable wax or paraffin-based sealant compositions are those available from Michelman, Inc., Cincinnati, Ohio, such as Michem®-Wood Coat 50.

The sealant composition is present in the treatment solution at a level of at least 0.1 percent by weight, often at least 0.25 percent by weight, typically at least 0.5 percent by weight, and in some cases at least 1.0 percent by weight. When the level of sealant composition in the treatment solution is too low, the wood treating materials in the treated wood may be leached out or removed by environmental water and moisture. The sealant composition is present in the treatment solution at a level of up to 20 percent by weight, often up to 16 percent by weight, typically up to 12 percent by weight, and in some cases up to 10 percent by weight. When the level of sealant material is too high, the treatment solution may be too viscous to be applied properly and may not have the required ability to penetrate the wood. The sealant composition may be present in the treatment solution in any range of values inclusive of those stated above.

The pH of the treatment solution is greater than 9.0, often from 9.0-14.0, typically from 10.0-14.0, and in many cases about 13.0. When the treatment solution is used in diluted form, it is desirable to maintain the pH of the solution at 11.2 to 11.4.

The treatment solution may include borax, or other suitable borates, such as, for example, disodium octaborate tetrahydrate (DOT) as an insecticidal agent, as well as a bactericide or a fungicide. When borax and/or other borate, an insecticide, and/or a fungicide are used, they are independently present in the treatment solution at a level of at least 0.01 percent by weight, often at least 0.1 percent by weight, typically at least 0.15 percent by weight, and in some cases at least 0.2 percent by weight. When the level of borax, insecticide, and/or fungicide in the treatment solution is too low, the treated wood may not be adequately resistant to insect, termite, or microbial infestation. The borax, insecticide, and/or fungicide are independently present in the treatment solution at a level of up to 12 percent by weight, in some situations up to 10 percent by weight, often up to 5 percent by weight, typically up to 3 percent by weight, and in some cases up to 2 percent by weight. When the level of borax, insecticide, and/or fungicide is too high, the treatment solution may not be economically used on a commercial scale. The borax, insecticide, and/or fungicide may independently be present in the treatment solution in any range of values inclusive of those stated above.

The bactericide or fungicide can be any suitable agent which does not substantially affect the ability of the aqueous solution to preserve the treated wood products. Examples of suitable bactericides and fungicides include, but are not limited to, DOWCIL-75, available from Dow Chemical Company, Midland, Mich.; parabens, such as methyl paraben and propyl paraben; disodium cyanodithioimidocarbonate; methylene bis thiocyanate; isothiazolin; glutaraldehyde; dithiocarbamates; quaternary ammonium compounds; dibromonitrilopropionamide; dibromo dicyano butane; dodecylguanidine hydrochloride; organophosphate insecticides, such as malathion, ethl-parathion and diazinon; organosulfur insecticides, such as tetradifon, propargite, and ovex, carbamate insecticides, such as carbaryl, methomyl, carbofuran, aldicarb, oxamyl, thiodicarb, methiocarb, propoxur, bendiocarb, carbosulfam, aldoxycarb, promecarb, and fenoxycarb; formamidine insecticides, such as amitraz; dinitropheol insecticides, such as 2,4-dinitrophenol; organotin insecticides, such as cyhexatin; pyrethroid insecticides, such as allethrin, tetramethrin, fenvalerate, acrinathrin, and permethrin; nicotinoid insecticides, such as 1-(6-chloro-3-pyridin-3-ylmethyl)-n-nitro-imidazolidin-2-ylidenamine, and mixtures thereof.

When a rheology modifier is included in the present treatment solution, it is included at a level of at least 0.01 percent by weight, often at least 0.1 percent by weight, typically at least 0.15 percent by weight, and in some cases at least 0.2 percent by weight. When the level of rheology modifier in the treatment solution is too low, the treatment solution may not have an optimum flow profile and resulting in not enough treatment solution penetrating the wood. The rheology modifier is present in the treatment solution at a level of up to 5 percent by weight, often up to 4 percent by weight, typically up to 3 percent by weight, and in some cases up to 2 percent by weight. When the level of rheology modifier is too high, the treatment solution may be too viscous to be applied properly and may not have the required ability to penetrate the wood. The rheology modifier may be present in the treatment solution in any range of values inclusive of those stated above.

Any suitable rheology modifier may be used in the present treatment solution, so long as it is able to provide a flow profile to the treatment solution that allows the treatment solution to impregnate and/or infuse into the wood to be treated. Examples of suitable rheology modifiers include, but are not limited to, thickening agents including cellulosic agents, such as hydroxymethyl cellulose, lignum, and carboxymethyl cellulose; acrylic thickeners, such as alkali swellable latexes; natural gums, such as xanthan and guar; byproducts from the manufacture of paper, such as lignum, lignin, cuminol, and culmonol; and acrylamide-based thickeners.

As used herein and in the claims, the term “lignum” refers to polymers and tissues found in wood, which may be isolated, for example, during wood chipping, wood pulping, and other such operations performed in the manufacture of paper and paper products.

As used herein and in the claims, the term “lignin” refers to any of the complex polymers that are deposited within the cellulose of a plant cell, as well as derivatives thereof, that tend to act as a natural glue by tying together cellulose fibers, making the plant rigid, which have been subsequently removed and isolated from the plant, and impart changes in the rheological properties of solutions that they have been added to. Examples of lignin and modified lignin include, but are not limited to those available under the trade names KRAFTSPERSE, REAX, POLYFON and INDULIN from MeadWestvaco Corporation, Charleston, S.C.

As used herein and in the claims, the term “culmonol” refers to natural substances occurring in various plants and trees which may be isolated, for example, during wood chipping, wood pulping, and other such operations performed in the manufacture of paper and paper products.

As used herein and in the claims, the term “wetting agent” refers to a material, that when added to a liquid, increases the liquid's ability to penetrate or spread over the surface of a given substrate.

When a wetting agent is included in the present treatment solution, it is included at a level of at least 0.01 percent by weight, often at least 0.1 percent by weight, typically at least 0.15 percent by weight, and in some cases at least 0.2 percent by weight. When the level of wetting agent in the treatment solution is too low, the treatment solution may not adequately penetrate into the wood during treatment. The wetting agent is present in the treatment solution at a level of up to 10 percent by weight, often up to 5 percent by weight, typically up to 4 percent by weight, and in some cases up to 2 percent by weight. When the wetting agent is too high, the treatment solution may tend to foam during treatment, which may create operational problems on a commercial scale. The wetting agent may be present in the treatment solution in any range of values inclusive of those stated above.

Any suitable wetting agent may be used in the present treatment solution. Examples of suitable wetting agents include, but are not limited to, silicates, such as metasodium silicate; anionic surfactants, such as sodium dodecyl sulfate and sodium lauryl sulfate; cationic surfactants; amphoteric surfactants; zwitterionic surfactants; and phosphates, such as trisodium phosphate and tetrasodium pyrophosphate.

In some cases, the various components of the treatment solution may not be compatible with each other or the generally water-based carrier solvent of the treatment solution. Compatibility is the ability of specified components to form homogeneous (one-phase) mixtures. When such is the case, one or more coupling agents may be added to the formulation. Coupling agents generally include co-solvents, surfactants, or other wetting agents that improve the compatibility of various formulation components with the carrier solvent. For example, a coupling solvent may be an active solvent for a resin component to be dissolved in the carrier solvent. Coupling agents increase the limit of dilution of hydrophilic resins with water and may improve treatment solution performance due to better compatibility of various combinations of treatment solution components. Examples of coupling agents that may be used in the present treatment solution include, but are not limited to, glycol ethers, such as ethylene glycol monoalkyl ethers, diethylene glycol monoalkyl ethers, and propylene glycol monoalkyl ethers available from Eastman Chemical Company, Kingsport, Tennessee; linear or branched C₁- C₁₂ alcohols; linear or branched C₁- C₁₂ acetates; alkali salts of alkyl, aryl, or alkylaryl sulfonates, such as the sodium or ammonium salts of xylene sulfonate or naphthalene sulfonate; betaine surfactants, such as fatty amidoalkyl betaines; fatty acids; ketones, such as acetone, methylethylketone, methyl isobutyl ketone and D-limonene; and the like, as well as mixtures thereof.

When a coupling agent is included in the present treatment solution, it is included at a level of at least 0.01 percent by weight, often at least 0.1 percent by weight, typically at least 0.15 percent by weight, and in some cases at least 0.2 percent by weight. When the level of coupling agent in the treatment solution is too low, the treatment solution may separate into two or more phases on standing, making it difficult to handle or to have a short shelf life due to instability. The coupling agent is present in the treatment solution at a level of up to 20 percent by weight, often up to 15 percent by weight, typically up to 10 percent by weight, and in some cases up to 5 percent by weight. When the level of coupling agent is too high, it may alter desirable properties of the treatment solution. For example, it may require more energy to dry the treated wood. The coupling agent may be present in the treatment solution in any range of values inclusive of those stated above.

The treatment solution may include any other desirable additive, such as a suitable dye or staining agent.

In a presently preferred embodiment, the present wood treatment solution includes 69.5-92 wt. % water, 4-12 wt. % sodium silicate, 4-12 wt. % sealant composition, 0-2 wt. % wetting agent, 0-2 wt. % rheology modifier, 0-2 wt. % borax, and 0-0.5 wt. % bactericide or fungicide. Further, in this embodiment, the wetting agent is a mixture of trisodium phosphate and sodium metasilicate, the sealant composition is a styrene-butadiene copolymer, and the rheology modifier is a mixture of lignum and culmonol.

In an embodiment of the present invention, the treatment solution is in a “concentrated” form, where the total solids of the treatment solution is at least 20 wt. % and, just prior to use, the concentrated treatment solution is d with a suitable solvent, such that the total solids of the diluted treatment solution is less than 10 wt. %. Suitable solvents include, but are not limited to, water miscible hydrocarbons, alcohols, and water. Total solids are determined by placing a known weight of a treatment solution in an oven at 60° C. for 12 hours and measuring the weight of the residual solids. The percent solids is calculated by dividing the weight of the residual solids by the original weight of the treatment solution and multiplying by 100.

The method of treating wood of the present invention includes pressure treating the wood products with the present treatment solution. The present method is useful for treating dried and/or engineered wood products and/or green lumber.

The pressure treating method of the present invention includes the following steps: placing the material in a pressure vessel and optionally applying a vacuum; contacting the material with the present treatment solution; increasing the pressure in the pressure vessel; draining the aqueous solution and optionally reducing the pressure by applying a vacuum; and drying the treated wood product through the application of energy. The application of pressure, followed by the application of a vacuum, may be repeated, as desired, to increase the penetration of the treatment solution into the wood.

In an alternative method, wood particles are slurried in the treatment solution with a glue. The slurry is injected into a press, for instance, a steam press, and the slurry is pressed to form a board or other engineered wood product. The engineered wood product can be fiberboard, particleboard, or oriented strand board. The wood product is then cured. As a further alternative, the aqueous solution and/or other additives can be injected directly into the press prior to pressing and curing.

The application of energy includes the use of radiant heat, electrical current, microwaves, lasers, convection ovens, dehydration, spot heating to high temperatures for short periods of time, and the like.

The treatment solution may be applied by pressure treating, soaking, spraying, painting, washing, dipping, rubbing, mixing, blending, infusion, and the like, as well as any combination of such methods.

While not wishing to be held to any one theory, it is believed that the sodium silicate and other treatment additives of the treatment solution are able to penetrate into the interior of the wood cells. When a suitable form and amount of energy is subsequently applied, sodium silicate polymerizes and is no longer capable of exiting from the cellular structure. The sealant composition resides in the extracellular portion of the wood and further prevents escape of treatment components due to leaching from environmental water or moisture. These changes provide the resulting fire-inhibiting properties, as well as resistance to the growth of fungi, attack by termites and moisture properties, and long-term moisture resistance to the wood.

In order to treat the wood products in accordance with the present invention, the wood product is placed in a pressure vessel. The door of the pressure vessel is closed, and optionally, a vacuum is applied to the pressure vessel. When the vacuum is applied, the pressure in the pressure vessel is reduced to less than 750 mm Hg, in many cases to less than 500 mm Hg, typically to less than 300 mm Hg, and in some cases to less than 200 mm Hg. If the pressure is too high when the vacuum is applied, the treatment solution may not adequately penetrate into the interior of the wood cells. When the vacuum is applied, the pressure in the pressure vessel is at least 1 mm Hg, in many cases at least 10 mm Hg, typically to at least 20 mm Hg, and in some cases at least 30 mm Hg. The pressure is limited based on the rating of the pressure vessel. Further, when the pressure is too low, excessive foaming of the treatment solution may result. When a vacuum is applied, the pressure in the pressure vessel may be any range of values inclusive of those stated above.

When the pressure vessel is pressurized, the pressure will be at least 10 pounds per square inch (psi), in many cases at least 20 psi, typically at least 30 psi, and in some cases at least 40 psi greater than atmospheric pressure. When the pressure in the pressure vessel is too low, the treatment solution may not adequately penetrate into the wood. When the pressure vessel is pressurized, the pressure can be up to 500 pounds per square inch (psi), in many cases up to 300 psi, typically up to 250 psi, and in some cases up to 200 psi greater than atmospheric pressure. The upper limit of pressure is typically limited by the pressure rating of the pressure vessel. In an embodiment of the present invention, the pressure of the pressure vessel is 40 to 160 psi in excess of atmospheric pressure when applied to the wood products. In another embodiment of the present invention, a pressure of 40 psi is applied when particleboard, MDF, and OSB are treated using the present method. In a further embodiment of the present invention, a pressure of 140 psi is applied when natural wood products are treated using the present method.

During pressure treatment, the treatment solution may be circulated under pressure for between twenty and ninety minutes. Wood products are typically treated for thirty minutes. Particleboard, MDF, OSB, and natural wood products are treated for thirty to ninety minutes. After treatment, the chamber is drained and optionally, a vacuum, as described above, may be applied for five to twenty minutes. The chamber is then opened, and the treated wood product is removed.

The final step requires the application of energy to the treated wood. In an embodiment of the present invention, the treated wood product is either placed in a drying kiln and slow-dried for twenty-four hours with hot air and steam, air dried for ten days, or microwave dried for up to eight hours.

The treatment solution of the present invention can also be used in a variety of methods commonly used for preparation of “engineered” wood products, such as, without limitation, particleboard, fiberboard, and oriented strand board. These wood products are generally prepared by forming a slurry of wood fibers or particles and an appropriate glue. The slurry is placed in a steam press, forming the wood product. The wood product is subsequently cured. According to one embodiment of the present invention, the cured wood product is pressure treated in the presence of the treatment solution, as described above.

The wood product can also be treated with the treatment solution at an earlier stage. In one version of the method of the present invention, the treatment solution and any additional additives are mixed into the slurry of wood fibers or particles and glue, prior to placing the slurry into the steam press. Alternatively, the treatment solution and additives are added to the press after the slurry is placed into the press. Importantly, the superior penetrating and preservation activity of the treatment solution according to the present invention allows the addition of the treatment solution and/or any further additives at any time during the preparation of the engineered wood product, or afterward, so long as the addition of the treatment solution is physically possible.

### EXAMPLES 1 AND 2

This Example demonstrates the non-leaching quality of wood treated using the pressure treating method of the present invention. The following solution is prepared:

| | |
|---|---|
| Sodium Silicate | 20% |
| Sodium Metasilicate | 2% |
| Trisodium Phosphate | 0.5% |
| Lignum¹ | 0.5% |
| Culmonol | 0.5% |
| Styrene-Butadiene Copolymer² | 4.0% |
| 5 mol Borax | 5.0% |
| Water | 67.5% |

¹MeadWestvaco Corp., Charleston, SC.
²Dow Chemical Co., Midland, MI.

Two sets of 2 inches by 2 inches cubes of southern yellow pine are cut. The first set is treated by applying the above-described solution at 100 psi for five minutes and then drying the wood cubes in a kiln at 60° C. for twenty-four hours. These treated wood blocks constituted Example 1.

A second set of 2 inches by 2 inches yellow pine cubes are treated by applying a 20% solution of sodium silicate at 100 psi for five minutes and the wood blocks air dry at ambient conditions for twenty-four hours. These treated wood blocks constituted Example 2.

Both sets of treated blocks soak for fourteen days in water. After the soak period, the blocks of Example 1 have greater than 0.3% borate content, and the blocks of Example 2 have no detectable level of borate. The borate level in Example 1 exceeded the AWPA level recommended for Formosa termites.

### EXAMPLES 3 AND 4

Southern yellow pine boards (5 cm×15 cm) were treated using the present method. The following treatment solutions were prepared:

| Ingredient | Ex. 3 | Ex. 4 |
|---|---|---|
| Sodium Silicate | 20% | 20% |
| Sodium Metasilicate | 2% | 2% |
| Trisodium Phosphate | 0.5% | 0.5% |
| Lignum¹ | 0.5% | 0.5% |
| Culmonol | 0.5% | 0.5% |
| Styrene-Butadiene Copolymer² | 4% | 4% |
| 5 mol Borax | 5.0% | 8.0% |
| Water | 67.5% | 64.5% |

¹MeadWestvaco Corp., Charleston, SC.
²Dow Chemical Co., Midland, MI.

The treatment solutions were applied at 100 psi for five minutes and then dried in a kiln at 60° C. for twenty-four hours. The boards were then cut into 1 meter lengths, with a thin wafer being cut from each length for measuring initial borate levels.

The borate levels were determined by grinding the samples and digesting them in nitric acid/hydrogen peroxide. The extract from the digestion was analyzed using inductively coupled plasma spectroscopy (ICP). Five samples were include and were exposed to repeating cycles that included:

(1) exposure to combined ultra-violet radiation and infra red radiation exposure for forty-eight hours at 50°-60° C.;

(2) intermittent water spray for one hour followed by three hours with no spray, this regime was repeated twelve times (forty-eight hours total);

(3) freezing at −15° C. for forty-eight hours.

The samples were evaluated initially and after five cycles. The results are summarized in the table below.

| | Initial Boron Level | Final Boron Level | Boron Retention |
|---|---|---|---|
| | (wt. %) | (wt. %) | (%) |
| Example 3 | 0.108 | 0.048 | 44 |
| Example 4 | 0.153 | 0.074 | 49 |

The data demonstrate the excellent retention of the present treatment product when applied to Southern Yellow Pine using the present treatment method.

### EXAMPLE 5

Douglas fir boards (5 cm×15 cm) were treated using the solution of Example 3 applied using the present method. The treatment solution was applied at 100 psi for five minutes and then dried in a kiln at 60° C. for twenty-four hours. The boards were then cut into 1 meter lengths, with a thin wafer being cut from each length for measuring initial borate levels. The borate levels were determined as described above. Five samples were include and were exposed to repeating cycles as described above. The samples were evaluated initially and after five cycles. The results are summarized in the table below.

| | Initial Boron Level | Final Boron Level | Boron Retention |
|---|---|---|---|
| | (wt. %) | (wt. %) | (%) |
| Example 5 | 0.108 | 0.059 | 55 |

The data demonstrate the excellent retention of the present treatment product when applied to Douglas Fir using the present treatment method.

The present invention has been described with reference to specific details of particular embodiments thereof. It is not intended that such details be regarded as limitations upon the scope of the invention except insofar as and to the extent that they are included in the accompanying claims.

The invention claimed is

1. A method for treating wood and wood products comprising:
(a) providing wood or a wood product to be treated;
(b) providing a treatment solution comprising:
(i) an alkali silicate; and
(ii) a sealant composition;
(c) pressure treating the wood or wood product with the treatment solution; and
(d) applying energy to the treated wood or wood product.

2. The method of claim 1, wherein the alkali silicate solution (i) comprises from 4 wt. % to 60 wt. % alkali silicate.

3. The method of claim 1, wherein the alkali silicate (i) in the treatment solution is sodium silicate.

4. The method of claim 1, wherein the wood or wood products are selected from the group consisting of dried lumber, green lumber, oriented strand board, medium-density fiberboard, plywood, particleboard, paper, cardboard, paper towels, sponges, porous plastics, and fabrics.

5. The method of claim 1, wherein the sealant composition comprises one or more selected from the group consisting of wax, paraffin, paraffin wax dispersed in mineral oil, wax in the form of micronized particles, a mixture of a cyclodimethylsiloxane fluid, and a polydiorganosiloxane-polyoxyalkylene copolymer, oxyalkalene polymers, pyridine containing polymers, amine modified polybutadienes, vinyl polymer latexes, styrene butadiene copolymers, hydrogenated styrene butadiene copolymers, thermosetting styrene butadiene copolymers, a styrene-butadiene rubber latex, styrene block copolymers, a moisture-curable silylated polyurethane prepolymer, a polyethylene wax, an organo silane, a water-based polymeric binder and a wax hydrophobic filler, and mixtures thereof.

6. The method of claim 1, wherein the sealant composition is present in the treatment solution at a level of from 0.1 wt. % to 20 wt. %.

7. The method of claim 1, wherein the treatment solution further comprises one or both of borax and disodium octaborate tetrahydrate.

8. The method of claim 7, wherein the borax and disodium octaborate tetrahydrate are present at a level of from 0.01 wt. % to 10 wt. %.

9. The method of claim 1, wherein the treatment solution further comprises one or more of a bactericide, insecticide, or fungicide.

10. The method of claim 9, wherein the one or more bactericides, insecticides, or fungicides are selected from the group consisting of methyl paraben, propyl paraben, disodium cyanodithioimidocarbonate, methylene bis thiocyanate, isothiazolin, glutaraldehyde, dithiocarbamates, quaternary ammonium compounds, dibromonitrilopropionamide, dibromo dicyano butane, dodecylguanidine hydrochloride, organophosphate insecticides, organosulfur insecticides, carbamate insecticides, formamidine insecticides, dinitrophenol insecticides, organotin insecticides, pyrethroid insecticides, and nicotinoid insecticides.

11. The method of claim 9, wherein the bactericides, insecticide, or fungicides are present in the treatment solution at a level of from 0.01 wt. % to 10 wt. %.

12. The method of claim 1, wherein the treatment solution further comprises one or more rheology modifiers.

13. The method of claim 12, wherein the rheology modifier is one or more selected from the group consisting of cellulosic agents, lignum, lignin, culmonol, acrylic thickeners, alkali swellable latexes, natural gums, and acrylamide-based thickeners.

14. The method of claim 12, wherein the rheology modifier is present in the treatment solution at a level of from 0.01 wt. % to 5 wt. %.

15. The method of claim 1, wherein the treatment solution further comprises one or more wetting agents.

16. The method of claim 15, wherein the wetting agent is one or more selected from the group consisting of metasodium silicate, anionic surfactants, cationic surfactants, amphoteric surfactants, zwitterionic surfactants, trisodium phosphate, and tetrasodium pyrophosphate.

17. The method of claim 15, wherein the wetting agent is present in the treatment solution at a level of from 0.01 wt. % to 10 wt. %.

18. The method of claim 1, wherein the treatment solution further comprises one or more coupling agents.

19. The method of claim 18, wherein the coupling agent is one or more selected from the group consisting of glycol ethers, linear or branched C₁-C₁₂ alcohols, linear or branched C₁-C₁₂ acetates, alkali salts of alkyl, aryl, or alkylaryl sulfonates, betaine surfactants, fatty acids, ketones, and D-limonene.

20. The method of claim 18, wherein the coupling agent is present in the treatment solution at a level of from 0.01 wt. % to 20 wt. %.

21. The method of claim 1, wherein the sodium silicate treatment solution comprises 69.5 to 92 wt. % water, 4 to 12 wt. % sodium silicate, 4 to 12 wt. % of a sealant composition, 0 to 2 wt. % of a wetting agent, 0 to 2 wt. % of a rheology modifier, 0 to 2 wt. % of a borate, and 0 to 0.5 wt. % bactericide, insecticide, or fungicide.

22. The method of claim 21, wherein the wetting agent is a mixture of trisodium phosphate and sodium metasilicate, the sealant composition is a styrene-butadiene copolymer, the rheology modifier is a mixture of lignum and culmonol, and the borate is one or both of borax and disodium octaborate tetrahydrate.

23. The method of claim 1, wherein the pressure treatment steps include:
placing the wood material in a pressure vessel and applying a vacuum;
contacting the wood material with the treatment solution;
increasing the pressure in the pressure vessel; and
draining the treatment solution;

24. The method of claim 23, wherein the steps of applying a vacuum, contacting the wood material with the treatment solution, and increasing the pressure in the pressure vessel are repeated.

25. The method of claim 1, further comprising the step of drying the treated wood product through the application of energy.

26. The method of claim 23, further comprising the steps of:
optionally applying pressure followed by the application of a vacuum and repeating such step; and
drying the treated wood product through the application of energy.

27. The method of claim 25, wherein the application of energy includes applying one or more of radiant heat, electrical current, microwaves, lasers, convection ovens, dehydration, and spot heating to high temperatures for short periods of time.

28. The method of claim 23, wherein the pressure in the pressure vessel is from 10 to 500 psi.

29. A piece of wood or wood product treated using the method of claim 1.

30. A piece of wood or wood product treated using the method of claim 7.

31. A structure built using the wood or wood product of claim 29.

32. A structure built using the wood or wood product of claim 30.

33. An aqueous wood treatment solution comprising an alkali silicate and a sealant composition.

34. The aqueous wood treatment solution of claim 33, further comprising one or more materials selected from the group consisting of a rheology modifier, a borate, a bactericide, an insecticide, and a fungicide.

35. The aqueous wood treatment solution of claim 34, wherein the alkali silicate is present at from 4 to 12 wt. %, the sealant composition is present at from 4 to 12 wt. %, the wetting agent is present at from 0 to 2 wt. %, the rheology modifier is present at from 0 to 2 wt. %, the borate is present at from 0 to 2 wt. %, and the bactericide, insecticide, and fungicide are present at from 0 to 0.5 wt. %, at least one of the wetting agent, the rheology modifier, the borate, the bactericide, insecticide, and fungicide being present in the treatment solution.

36. The aqueous wood treatment solution of claim 34, wherein the alkali silicate is sodium silicate, the wetting agent is a mixture of trisodium phosphate and sodium metasilicate, the sealant composition is a styrene-butadiene copolymer, the rheology modifier is a mixture of lignum and culmonol, and the borate is one or both of borax and disodium octaborate tetrahydrate.
